(19) United States
(12) Patent Application Publication
(10) Pub. No.: US 2006/0079638 A1
(43) Pub. Date: Apr. 13, 2006

(54) Polybutylene terephthalate resin composition

(75) Inventors: Mitsunori Matsushima, Shizuoka (JP); Miki Watanabe, Shizuoka (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: WinTech Polymer Ltd., Tokyo (JP)

(21) Appl. No.: 11/240,378

(22) Filed: Oct. 3, 2005

(30) Foreign Application Priority Data
Oct. 7, 2004 (JP) 2004-294442

(51) Int. Cl. C08L 51/08

(52) U.S. Cl. 525/63

(57) ABSTRACT

It is an object of the present invention to provide a polybutylene terephthalate resin composition, excellent in toughness, in hydrolysis proofing and moreover in chemical proofing. Specifically, there are blended (A) 100 parts by weight of a polybutylene terephthalate resin, (B) 20 to 40 parts by weight of an acrylic core-shell polymer in which a butadiene component is not contained, (C) 0.1 to 5 parts by weight of an epoxy compound, and (D) 0.05 to 1 parts by weight of an aromatic carbodiimide compound.

### TECHNICAL FIELD

The present invention relates to a polybutylene terephthalate resin composition having excellent toughness, resistance to hydrolysis, and resistance to chemicals, and specifically relates to a polybutylene terephthalate resin composition which gives small deterioration in toughness and is suitable for long period of use under environments of organic solvent and gasoline.

### PRIOR ART

Owing to excellent mechanical properties, electric properties, heat resistance, weather resistance, water resistance, chemicals resistance, and solvent resistance, the polybutylene terephthalate resins are used as engineering plastic in wide fields including automobile parts, electric and electronic parts. With the widening in their use fields, the performance required to them increases, and they are wanted to have further improved toughness (impact strength), resistance to hydrolysis, resistance to chemicals, and other characteristics.

Currently, JP-A-56161452and JP-Al-174557disclose a resin composition containing a carbodiimide compound and an epoxy compound to improve the resistance to hydrolysis of polybutylene terephthalate resins, and JP-A-60 219255 discloses a resin composition of polybutylene terephthalate resin containing a carbodiimide compound, an epoxy compound, and a butadiene-based graft copolymer to improve the impact strength. There exists, however, no resin composition that satisfies all of the toughness (impact-strength), the resistance to hydrolysis, and the resistance to chemicals. For example, the resin composition of JP-A-60-219255 gives inferior resistance to chemicals of the butadiene-based graft copolymer, though the resistance to hydrolysis of the polybutylene terephthalate resin is improved and it is effective for improving the impact strength, thus the resin composition cannot be used for the parts which contact with liquid or vapor of an organic solvent, gasoline, and the like, thereby having a problem of significantly sacrificing the excellent resistance to chemicals inherent to the polybutylene terephthalate resin.

### DISCLOSURE OF THE INVENTION

An object of the present invention is to provide a polybutylene terephthalate resin composition which has excellent toughness, resistance to hydrolysis, and resistance to chemicals.

To solve the above issues, the inventors of the present invention carried out intensive study, and found that the object is achieved by adding an acrylic core-shell polymer containing no butadiene component, an epoxy compound, and an aromatic carbodiimide compound to a polybutylene terephthalate resin, thus completed the present invention.

The present invention provides a polybutylene terephthalate resin composition having (A) 100 parts by weight of a polybutylene terephthalate resin, (B) 20 to 40 parts by weight of an acrylic core-shell polymer containing no butadiene component, (C) 0.1 to 5 parts by weight of an epoxy compound, and (D) 0.05 to 1 parts by weight of an aromatic carbodiimide compound.

### DETAILED DESCRIPTION OF THE INVENTION

The resin composition according to the present invention has excellent toughness, resistance to hydrolysis, and resistance to chemicals, and further maintains stable toughness for a long period even in environments exposing to liquid or vapor of organic solvent, gasoline, and the like.

The components structuring the resin material according to the present invention are described below in detail. The (A) polybutylene terephthalate resin (PBT resin) which is the basic resin of the resin composition according to the present invention is a polybutylene terephthalate-based resin which is obtained by polycondensation of a dicarboxylic acid component containing at least terephthalic acid or an ester-forming derivative thereof (lower alcohol ester, for example), and a glycol component containing at least an alkylene glycol of C4 (1,4-butane diol), or an ester-forming derivative thereof. The PBT resin is not limited to homo-PBT resin, and it may be a copolymer (copolymerized PBT resin) containing 60% or more by mole of butylene terephthalate unit, (particularly about 75 to 95% by mole). Examples of applicable dicarboxylic acid component (comonomer component) other than terephthalic acid and the ester-forming derivative thereof in the copolymerized PBT resin are: aromatic dicarboxylic acid component (C₆-C₁₂ aryl dicarboxylic acid such as isophthalic acid, phthalic acid, naphthalene dicarboxylic acid or diphenylether dicarboxylic acid); aliphatic dicarboxylic acid component (C₄-C₁₆ alkyl dicarboxylic acid such as succinic acid, adipic acid, azelaic acid or sebacic acid, C₅-C₁₀ cycloalkyl dicarboxylic acid such as alkyl dicarboxylic acid and cyclohexane dicarboxylic acid, and the like); and an ester-forming derivative thereof. These dicarboxylic acids can be used separately or in combination of two or more of them. Preferred examples of the dicarboxylic acid component (comonomer component) include: aromatic dicarboxylic acid component (particularly C₆-C₁₀ aryl dicarboxylic acid such as isophthalic acid); aliphatic dicarboxylic aid component (particularly C₆-C₁₂ alkyl dicarboxylic acid such as adipic acid, azelaic acid or sebacic acid). Examples of glycol component (comonomer component) other than 1,4-butandiol are: aliphaticdiol component [alkylene glycol (such as C₂-C₁₀ alkylene glycol such as ethylene glycol, propylene glycol, trimethylene glycol, 1,3-butylene glycol, hexamethylene glycol, neopentyl glycol or 1,3-octane diol, or polyoxy C₂-C₄ alkylene glycol such as diethylene glycol, triethylene glycol or dipropylene glycol), alicyclic diol such as cyclohexane dimethanol or hydrogenated bisphenol A, and the like]; aromatic diol component [aromatic alcohol such as bisphenol A or 4,4-dihydroxybiphenyl, C₂-C₄ alkylene oxide additive of bisphenol A (for example, ethylene oxide 2-mole additive of bisphenol A, and propylene oxide 3-mole additive of bisphenol A), and the like]; and an ester-forming derivative thereof. Also these glycol components can be used separately or in combination of two or more of them. Preferred glycol component (comonomer component) includes the aliphatic diol component (particularly C₂-C₆ alkylene glycol, polyoxy C₂-C₃ alkylene glycol such as diethylene glycol, and alicyclic diol such as cyclohexane dimethanol. The homo-PBT resin or the copolymerized PBT resin which are generated by polycondensation of the above-compounds as the monomers can be used as the (A) component of the present invention. The homo-PBT resin and the copolymerized PBT resin can be used separately or in combination of two or more of them. Combined use of a non-modified PBT resin (homo-PBT resin) and a copolymerized PBT resin is also useful. As the PBT resin, a thermoplastic branched PBT resin which belongs to the copolymerized PBT resin is applicable. The thermoplastic branched PBT resin is a polyester resin structured mainly by polybutylene terephthalate or butylene terephthalate monomer, having a branched structure formed by a reaction with a polyfunctional compound. The polyfunctional compound includes aromatic polycarboxylic acid (such as trimesicacid, trimellitic acid, pyromellitic acid, and there alcohol ester), and polyol component (such as glycerin, trimethylol ethane, trimethylol propane or pentaerythritol).

Regarding the acrylic core-shell polymer, containing no butadiene component, used as the (B) component in the present invention, the (B) component has a multilayer structure, and is preferably a core-shell type compound of a rubber layer having 1.0 μm or smaller average particle size enclosed by a glassy resin. According to the present invention, the rubber layer of the core-shell type compound may have 1.0 μm or smaller average particle size, preferably in a range from 0.2 to 0.6 μm. If the average particle size exceeds 1.0 μm, the effect of improving the impact strength becomes insufficient in some cases. The rubber layer of that core-shell type compound adopts an acrylic elastomer. In some cases, however, the rubber layer may be the one prepared by copolymerization/graft polymerization of silicon-based elastomer. The acrylic rubber is obtained by polymerizing an acrylic acid ester such as butylacrylate with a small amount of cross-linking monomer such as butylene acrylate. The acrylic acid ester includes, other than butyl acrylate, methyl acrylate, ethyl acrylate, propyl acrylate, hexyl acrylate, and 2-ethylhexylacrylate. The cross-linking monomer includes, other than butylene diacrylate, vinyl compound such as butylene dimethacrylate, ethylene glycol diacrylate, ethylene glycol dimethacrylate, butylene glycol diacrylate, butylene glycol dimethacrylate, oligoethylene glycol diacrylate, trimethylol propane, trimethylol propane diacrylate, trimethylol propane dimethacrylate or trimethylol propane trimethacrylate, and allyl compound such as allyl acrylate, allyl methacrylate, diallyl malate, diallyl fumarate, diallyl itanylate, monoallyl malate, monoallyl fumarate or trially cyanulate.

The silicon-based oligomer is prepared by polymerizing olganosiloxane monomer. Applicable organosiloxane includes hexamethyl tricyclosiloxane, octamethyl cyclosiloxane, decamethylpenta cyclosiloxane, dodecamethylhexa cyclosiloxane, trimethyltriphenyl siloxane, tetramethylphenyl cyclotetrasiloxane, and octaphenylcyclo tetrasiloxane.

The shell layer formed by a glassy resin of core-shell compound is formed by a vinyl-based copolymer. The vinyl-based copolymer is obtained by polymerizing or copolymerizing at least one monomer selected from the group consisting of an aromatic vinyl monomer, a cyanidated vinyl monomer, a methacrylic acid ester-based monomer, and an acrylic ester monomer. The rubber layer and the shell layer of that type of core-shell compound are generallybonded by graftbond. The graft copolymerization is obtained, if needed, by adding a graft crossing agent which reacts with the shell layer during the polymerization of rubber layer to provide the rubber layer with reaction group, followed by forming the shell layer. Examples of applicable graft crossing agent for the silicon-based rubber are organosiloxane having vinyl bond and organosiloxane having thiol, and preferably acroxysiloxane, methacroxysiloxane, and vinylsiloxane.

From the point of resistance to chemicals, the (B) acrylic core-shell polymer having no butadiene component is preferably the one which does not dissolve in a 1:1 mixture of toluene and isooctane.

The (B) component is added by the amounts from 20 to 40 parts by weight to 100 parts by weight of the (A) polybutylene terephthalate resin. If the quantity of (B) component is excessively small, the improving effect of impact strength which is an object of the present invention cannot be attained. If the quantity of (B) component is excessively large, the resistance to chemicals and the heat resistance are deteriorated, which is not preferable.

The epoxy compound of (C) component according to the present invention is a compound which has at least one epoxy group in the molecule. Examples of the epoxy compound are: bisphenol type epoxy compound prepared by the reaction between bisphenol A and epichlorohydrin at various mixing ratios; novorak type epoxy compound prepared from novorak resin and epichlorohydrin; polyglycidyl ester prepared from polycarboxylic acid and epichlorohydrin; alicyclic compound type epoxy compound prepared from alicyclic compound (dicyclopentadiene, and the like); glycidyl ether prepared from aliphatic compound having alcoholic hydroxyl group, such as butanediol and glycerin) and epichlorohydrin; and epoxy group-containing copolymer structured by epoxidated polybutadiene, unsaturated monomer having epoxy group, and other unsaturated monomer. These epoxy compounds can be used separately or in combination of two or more of them. As of these epoxy compounds, preferred ones are: bisphenol A type epoxy compound expressed by the following formula: 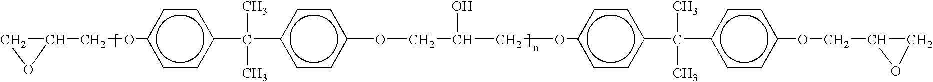
(where, n is the integer from 1 to 10); and copolymer containing epoxy group, such as ethylene/methacrylic acid glycidyl copolymer, ethylene/vinyl acetate/methacrylic acid glycidyl copolymer, ethylene/carbon monoxide/methacrylic acid glycidyl copolymer or ethylene/acrylic acid glycidyl copolymer. The epoxy compound according to the present invention may be substituted by halogen atom such as chlorine or bromine. However, existence of nitrogen atom which forms amino group is not preferable because coloring is induced.

The (C) component is added by the amounts from 0.1 to 5 parts by weight to 100 parts by weight of (A) polybutylene terephthalate resin. If the quantity of (C) component is excessively small, the effect to improve the resistance to hydrolysis, which is an object of the present invention, cannot be attained. If the quantity of (C) component is excessively large, degradation of flowability and generation of gelling component and carbide during the molding step likely occur, which is unfavorable.

The aromatic carbodiimide compound in the (D) component according to the present invention is a compound having carbodiimide group, (−N=C=N−), and containing aromatic component in the skeleton. When the skeleton thereof is structured only by aliphatic compound, the effect to improve the resistance to hydrolysis cannot be attained. Examples of applicable (D) component are: mono or dicarbodiimide compound such as diphenyl carbodiimide, di-2,6-dimethylphenyl carbodiimide, N-triyl-N′-phenyl carbodiimide, di-p-nitrophenyl carbodiimide, di-p-aminophenyl carbodiimide, di-p-hydroxyphenyl carbodiimide, di-p-chlorophenyl carbodiimide, di-p-methoxyphenyl carbodiimide, di-3,4-dichlorophenyl carbodiimide, di-2,5-dichlorophenyl carbodiimide, di-o-chlorophenyl carbodiimide, p-phenylene-bis-di-o-triyl carbodiimide, p-phenylene-bis-dicyclohexyl carbodiimide, p-phenylene-bis-di-p-chlorophenyl carbodiimide or ethylene-bis-diphenyl carbodiimide; and polycarbodiimide compound such as poly(4,4′-diphenylmethane carbodiimide), poly(3,5′-dimethyl-4,4′-biphenylmethane carbodiimide), poly(p-phenylene carbodiimide), poly(m-phenylene carbodiimide), poly(3,5′-dimethyl-4,4′-diphenylmethane carbodiimide), poly(naphthylene carbodiimide), poly(1,3-diisopropylphenylene carbodiimide), poly(1-methyl-3,5-diisopropylphenylene carbodiimide), poly(1,3,5-triethylphenylene carbodiimide) or poly(triisopropylphenylene carbodiimide). Two or more of them can be used in combination thereof. As of these, particularly preferable are di-2,6-dimethylphenyl carbodiimide, poly(4,4′-diphenylmethane carbodiimide), poly(phenylene carbodiimide), and poly(triisopropylphenylene carbodiimide)

The (D) component is added by amounts of from 0.05 to 1 part by weight to 100 parts by weight of (A) polybutylene terephthalate resin. If the quantity of (D) component is excessively small, the effect to improve the resistance to hydrolysis, which is an object of the present invention, cannot be attained. If the quantity of (D) component is excessively large, the flowability decreases, and the gelling component and the carbide likely occur during compounding and molding steps, which is not preferable.

As for the above (C) epoxy compound and (D) aromatic carbodiimide compound, addition of any one of them cannot attain the satisfactory resistance to hydrolysis. By the synergy effect of addition of both of these compounds, the excellent resistance to hydrolysis is attained.

The adding quantity of each of the (C) epoxy compound and the (D) aromatic carbodiimide compound is described above. The sum of them is preferably in a range from 0.3 to 4% by weight to the sum of the (A) polybutylene terephthalate resin and the (B) acrylic core-shell polymer containing no butadiene component. When the quantity thereof is excessively small, the effect to improve the resistance to hydrolysis, which is an object of the present invention, cannot be sufficient. When the quantity thereof is excessively large, the gelling component and the carbide likely occur during compounding, which is not preferable.

To further providing necessary characteristics to the composition of the present invention for each object thereof, the composition can contain known substances which are generally added to the thermoplastic resins and thermosetting resins: antioxidant, stabilizer such as heat stabilizing agent or ultraviolet light absorber, coloring agent such as dye or pigment, lubricant, plasticizer and crystallization-enhancing agent, crystal nucleation agent, and the like.

Depending on the object, the composition according to the present invention can contain inorganic or organic fibrous reinforcing agent and inorganic filler to a quantity not deteriorating the toughness. Examples of the fibrous reinforcing agent are general inorganic fiber such as glass fiber, carbon fiber, ceramic fiber, boron fiber, potassium titanate fiber or asbestos, and organic fiber such as aramid fiber. Examples of the inorganic filler are granule or powder material such as calcium carbonate, highly dispersible silicate, alumina, aluminum hydroxide, talc, clay, glass flake, glass powder, glass bead, quartz powder, silica sand, wollastonite, carbon black, barium sulfate, calcined gypsum, silicon carbide, boron nitride or silicon nitride, and inorganic compound in plate shape. These inorganic fillers may be used separately or in combination of two or more of them.

The resin composition according to the present invention can be easily prepared by an apparatus and a method generally used as the conventional method for preparing resin composition. Applicable method therefore is, for example, any of: (1) mixing respective components, forming pellets thereof by kneading and extruding them by a single screw or a twin screw extruder, and then molding the pellets; (2) preparing pellets having different compositions from each other, mixing the respective pellets at a specified mixing ratio to mold them together, and obtaining the molding article having the target composition; and (3) directly charging one or more of the respective components to the molding machine. A method in which a part of the resin components is finely powdered, which powder is then mixed with other components before introducing the molding machine, is a preferable one to attain uniform mixing of these components.

The resin composition according to the present invention has good moldability. Owing to the advantageous characteristic, the resin composition is readily molded by melting and kneading the composition and by applying ordinary molding method such as extrusion and injection molding, thereby attaining the molding article at high efficiency.

The molding article according to the present invention is particularly suitable for the injection or extrusion molding articles which are used in the applications exposing to liquid or vapor of organic solvent and gasoline.

### EXAMPLES

The present invention is described below in more detail by referring to Examples. These examples, however, do not limit the scope of the present invention. Examples 1 to 6, Comparative Examples 1 to 7 One hundred parts by weight of (A) polybutylene terephthalate resin was blended in dry state with (B) thermoplastic elastomer component, (C) epoxy compound, and (D) carbodiimide component at the respective mixing ratios given in Table 1. The blend was melted and kneaded at 250° C. by a 30 mmΦ twin screw extruder, and was palletized. The melted and kneaded pellets were dried at 140° C. for 3 hours, and then were injection-molded at 250° C. to fabricate ISO specimens. Various physical properties were determined using the specimens. The results are given in Table 1.

Detail of the applied components and the method for determining the physical properties are described in the following.

(A) polybutylene terephthalate (intrinsic viscosity 1.0), manufactured by WinTech Polymer Ltd.

(B) thermoplastic elastomer

(B-1) acrylic core-shell polymer: Paraloid EXL-2311, manufactured by Rohm and Haas Japan KK

(B-2) acrylic core-shell polymer: Paraloid EXL-2314, manufactured by Rohm and Haas Japan KK

(B′-1) EGMA: Bond-fast E, manufactured by Sumitomo Chemical Co., Ltd.

After pulverizing each of the above thermoplastic elastomers, each of them was immersed in a 1:1 mixture of toluene and isooctane at 25° C. The state was observed visually after 24 hours of immersion to check occurrence/not occurrence of dissolving. The result was that (B-1) and (B-2) were not dissolved, though they were swelled, and that (B′-1) and (B′-2) were dissolved.

(C) epoxy compound

(C-1) Epicoat 1004K, manufactured by YUKA Shell Epoxy Co., Ltd.

(C-2) Epicoat 1001, manufactured by YUKA Shell Epoxy Co., Ltd.

(D) carbodiimide compound

(D-1) aromatic polycarbodiimide: Stabaxol P, manufactured by Rhein Chemie Japan Ltd.

(D-2) aromatic polycarbodiimide: Stabaxol 1, manufactured by Rhein Chemie Japan Ltd.

(D′-1) aliphatic polycarbodiimide: CALBODILITE HMV-8CA, manufactured by Nisshinbo Industries, Inc.

<Charpy Impact Strength>

Determination was done conforming to ISO.

<Quantity of Swelling in Organic Solvent>

After drying the ISO specimen at 120° C. for 5 hours, it was accurately weighed. A solution of 1:1 toluene to isooctane was poured in an oil bath regulated to 60° C. The accurately weighed specimen was immersed in the solution for 240 hours. After the immersion for 240 hours, the specimen was taken out, and the surface thereof was wiped to remove the solution retained on the surface thereof. The specimen was then allowed to standing at 23° C. and 50% RH for 24 hours. After that, the specimen was accurately weighed. The quantity of swelling was determined by dividing the weight before immersion by the weight after immersion.

<Hydrolysis Life (PCT)>

The ISO specimens were put in a pressure cooker tester (121° C., 2 atm) to conduct the hydrolysis. The specimens were taken out from the cooker one by one at every 24 hours of interval. The taken-out specimens were allowed to standing at 23° C. and 50% RH for 24 hours, which were then subjected to tensile test in accordance with ISO. The treatment time until the tensile elongation becomes necking was defined to the hydrolysis life.

TABLE 1

| | | Examples | | | | | | Comparative Examples | | | | | | |
|---|---|---|---|---|---|---|---|---|---|---|---|---|---|---|
| | | 1 | 2 | 3 | 4 | 5 | 6 | 1 | 2 | 3 | 4 | 5 | 6 | 7 |
| (A) polybutylene terephthalate | | 100 | 100 | 100 | 100 | 100 | 100 | 100 | 100 | 100 | 100 | 100 | 100 | 100 |
| (B) thermoplastic elastomer | (B-1) | 20 | 30 | 30 | 30 | | | 30 | 30 | 30 | 10 | 50 | | |
| | (B-2) | | | | | 30 | 30 | | | | | | | |
| | (B′-1) | | | | | | | | | | | | 30 | |
| | (B′-2) | | | | | | | | | | | | | 30 |
| (C) epoxy compound | (C-1) | 1 | 1 | 3 | | 1 | 1 | | 1 | | | | 1 | 1 |
| | (C-2) | | | | 1 | | | | | | | | | |
| (D) carbodiimide | (D-1) | 0.3 | 0.3 | 0.5 | | 0.3 | | 0.3 | | | | | 0.3 | |
| | (D-2) | | | | 0.3 | | 0.3 | | | | | | | |
| | (D′-1) | | | | | | | | 0.3 | | | | | |

| | | | | | | | | | | | | | |
|---|---|---|---|---|---|---|---|---|---|---|---|---|---|
| ratio of [(C) + (D)]/[(A) + (B)] | 1.1 | 1 | 2.7 | 1 | 1 | 1 | 0.2 | 1 | — | — | — | 1 | 0.8 |
| Charpy impact strength [kJ/m²] | 76 | 84 | 86 | 85 | 86 | 88 | 80 | 82 | 79 | 22 | 85 | 85 | 83 |
| quantity of swelling in organic solvent [wt %] | 17 | 24 | 25 | 23 | 22 | 23 | 21 | 23 | 21 | 11 | 35 | 35 | 33 |
| hydrolysis life (PCT) [hr] | 72 | 72 | 120 | 120 | 96 | 120 | 48 | 24 | 24 | 24 | 24 | 72 | 24 |

1. A polybutylene terephthalate resin composition comprising (A) 100 parts by weight of a polybutylene terephthalate resin, (B) 20 to 40 parts by weight of an acrylic core-shell polymer in which a butadiene component is not contained, (C) 0.1 to 5 parts by weight of en epoxy compound, and (D) 0.05 to 1 parts by weight of an aromatic carbodiimide compound.

2. The polybutylene terephthalate resin composition according to claim 1, wherein said acrylic core-shell polymer (B) in which a butadiene compound is not contained is not dissolved in the solution obtained by mixing one part by weight of toluene and one part by weight of isooctane.

3. The polybutylene terephthalate resin composition according to claim 1, wherein the total amount of said epoxy compound (C) and said aromatic carbodiimide compound (D) is 0.3 to 4 parts by weight to the total amount of said polybutylene terephthalate resin (A) and said acrylic core-shell polymer (B) in which a butadiene component is not contained.

4. A molding article obtained by the injection molding or the extrusion molding of said polybutylene terephthalate resin composition according to claim 1 for use when coming into contact with an organic solvent or gasoline in liquid or vapor form.

5. The polybutylene terephthalate resin composition according to claim 2, wherein the total amount of said epoxy compound (C) and said aromatic carbodiimide compound (D) is 0.3 to 4 parts by weight to the total amount of said polybutylene terephthalate resin (A) and said acrylic core-shell polymer (B) in which a butadiene component is not contained.

6. A molding article obtained by the injection molding or the extrusion molding of said polybutylene terephthalate resin composition according to claim 2 for use when coming into contact with an organic solvent or gasoline in liquid or vapor form.
